(19) United States
(12) Patent Application Publication
(10) Pub. No.: US 2010/0142657 A1
(43) Pub. Date: Jun. 10, 2010

(54) SELECTION SCHEME FOR SELECTING A PEAK IN A CORRELATION SIGNAL

(76) Inventors: Eric Alliot, Cagnes Sur Mer (FR); Fabrizio Tomatis, Biot (FR)

Correspondence Address: HOGAN & HARTSON LLP, ONE TABOR CENTER, SUITE 1500, 1200 SEVENTEENTH ST, DENVER, CO, 80202, US

(21) Appl. No.: 12/445,057

(22) PCT Filed: Oct. 9, 2007
(86) PCT No.: PCT/IB2007/054106

§ 371 Date: Feb. 16, 2010

(30) Foreign Application Priority Data
Oct. 12, 2006 (EP) 06301043.3

(51) Int. Cl. H04L 27/06

(52) U.S. Cl. 375/343

(57) ABSTRACT

A method and associated module for selection of a maximum peak in a correlation signal corresponding to the correlation between a code periodically transmitted by a transmitter, and an input signal received by a receiver on a radio channel, includes a selection criteria which is the time recurrence of the same position of peaks of correlation, taking into account a margin around the peak position compensating for a drift due to a frequency offset between the receiver and the transmitter.

### FIELD OF THE INVENTION

The present invention generally relates to method and device for selecting a maximum peak of correlation and has been developed with particular attention paid to its possible application to telecommunication systems. By way of non-exhaustive example, telecommunication systems based upon CDMA (Code division multiple access) or GSM standardized by the 3GPP (Third Generation Partnership Project) or W-CDMA standards (Wideband Code Division Multiple Access), an asynchronous SDMA scheme, may be cited.

Such a device may be used for example in a mobile station of an UMTS (Universal Mobile Telecommunications System) radio communication system.

### BACKGROUND OF THE INVENTION

A mobile radio communication system generally includes one or more base stations, associated to a radio cell, and several mobile stations. Before any exchange of information can occur between a base station and a mobile station, a mobile station has to find the timing references of the transmission of the base station. This operation is called a search cell. Indeed when a mobile station is turned on, it does not have any knowledge of the timing references of the transmitting cell to which it is to be assigned.

The data transmitted by a base station are generally organized according to a hierarchical structure frame/slot/symbol/chip. In CDMA systems, for example, each frame, that lasts for example 10 millisecondes (ms) includes slots, for example 15 slots. Each slot is composed of symbols, for example 10 symbols. Each symbol is itself composed of chips, for example 256 chips.

In addition to channels for voice or data traffic, some radio communication systems also provides synchronization channels for transmitting data used by mobile stations for synchronizing their transceivers with the transmission of a particular base station.

In the W-CDMA standard, each base station is identified by a downlink scrambling code. There are 512 scrambling codes grouped into 64 code groups. All the CDMA channels transmitted by a base station are scrambled by the code identifying this base station except the synchronization channels.

In the W-CDMA standard, a cell search operation can be processed using, in a downlink physical channel, two synchronization channels, called the primary synchronization channel (PSCH) and the secondary synchronization channel (SSCH), and a pilot channel (CPICH).

The base station transmits, without synchronization with the other base stations, a primary synchronization code (Cₚ) whose length corresponds to 256 chips during the first symbol of each slot through the PSCH channel. The code Cₚ is the same for all the base stations. The PSCH channel thus provides the information about the slot reference timing. The mobile station has to search for this Cₚ code to establish the slot boundary of the cell.

The base station transmits a sequence (Cₛ) of 15 symbols (one symbol at the beginning of each slot in a frame) which uniquely identifies the scrambling code group of the base station.

The 3GPP standard proposes an initial cell search 3-steps procedure for acquiring a cell signal and synchronizing therewith. In the first step of this procedure, the mobile station searches for the slot timing reference by correlating the received signal through the PSCH channel with the Cₚ code, generated by the mobile station. In the second step of the procedure, the mobile station searches for the frame timing reference and determines the cell code group by correlating the received signal through the SSCH channel with each of the 64 possible code groups identifiers. In the third step of the procedure, the mobile station determines the scrambling code using the signal received through the CPICH channel.

The common process for determining a timing reference of a slot or of a frame in the 3-steps procedure usually includes the computation of one correlation signal per slot, the determination of a correlation profile by summing the correlation signals on several accumulated slots, the detection of a maximum peak in the correlation profile, and the selection of a detected peak. A detected correlation peak is selected according to the comparison of its amplitude with a threshold. If the amplitude of the detected maximum peak is higher than the threshold, the detected peak is selected as corresponding to the beginning of the slot or of the frame. Else, the detected peak is considered as a noise peak and is not taken into account.

The threshold usually depends on a Constant False Alarm Rate (CFAR) that is statistically determined. With such a CFAR threshold, a compromise has to be made between the wished False Alarm probability (ie the probability that a peak noise be selected as a timing reference) and the wished Good Detection probability (ie the probability of detecting most of the peaks effectively corresponding to a timing reference). Indeed, decreasing the False Alarm probability by taking a lower CFAR value, results in decreasing the good detection probability.

On the other hand, both the base stations and the mobile stations are provided with local oscillators to monitor the operations realized on the signal, such as sampling, modulating etc. The accuracy of the mobile station oscillator is much lower than the accuracy of the base station oscillator. For example, in an UMTS system where in the carrier frequency is 2 GHz (Giga Hertz), there may be a frequency offset between the base station and the mobile station up to +/− 30 kHz (Kilo Hertz). Such a high frequency offset decreases the performances of the synchronization procedure. Indeed it implies an amplitude decrease of the correlation peak when the received and local codes are in phase. And a noise peak may thus be higher than the decreased correlation peak, leading to selecting the noise peak as false timing reference.

Most of the techniques of the selection of correlation peak do not take into account the impact of the frequency offset between the base station and the mobile station. The synchronization methods based on a selection using CFAR thresholds, among others, do not give good synchronization results in presence of high frequency offset, because frequency offset modify the statistical features of the signal. The same problems are met in case of fading in the signal received by the mobile station, and also when the mobile station is located at cell boundary.

Document US 2004/0174849 discloses a cell search method and apparatus in a WCDMA system allowing to improve the cell search performances under high offset conditions. According to this document, one or more identification steps for identifying timing and code of oversampled signals are performed, and the resolution of the oversampled input signals is reduced before performing the one or more identification steps. But the method according to this document includes the selection of a peak value by comparing this peak value to a threshold. Such a selection step is not very satisfactory in presence of high frequency offset or in presence of fading. Indeed the amplitude of correlation peak corresponding to the real timing reference is decreased because of the fading or the high frequency offset, can be below the threshold and or below the amplitude of noise peaks.

Therefore there is a need for a scheme for selection of correlation peak that gives improved results in presence of one or more features among fading, high frequency offset and location at cell boundary.

### SUMMARY OF THE INVENTION

To address this need, according to a first aspect of the invention, there is provided a method for the selection of a maximum peak in a correlation signal corresponding to the correlation between a code and an input signal indicating periodically said code. The input signal can for example be received by a receiver on a radio channel from a transmitter.

This method comprises the steps of:

calculating a first correlation signal, along a 1^{st} time window of a given duration, indicative of the correlation between the code and at least one 1^{st} slice;

identifying a peak in the 1^{st} correlation signal;

calculating a second correlation signal, along a 2^{nd} time window of the same duration as the 1^{st} time window, indicative of the correlation between the code and at least one 2^{nd} slice;

identifying a peak in the second correlation signal;

if the location of the peak identified in the first correlation signal substantially corresponds to the location of the peak identified in the second correlation signal, selecting the peak identified in the second correlation signal.

In case that the correlation is calculated with several consecutive 1^{st} slices of the input signal, the respective beginnings of the 1^{st} slices are spaced one from the other by an integer multiple of said duration. The size of each 1^{st} slice corresponds to said duration.

In case that the correlation is calculated with several consecutive 2nd slices of the input signal, the respective beginnings of the 2nd slices are spaced one from the other by an integer multiple of said duration. The size of each 2nd slice corresponds to said duration.

In a preferred embodiment an HFO estimation process comprises a method according the invention that is launched more than once. For example a first and a second estimation process are carried out at mutually different frequencies. The first frequency is for example the nominal frequency minus half the maximum frequency offset and the second frequency is the nominal frequency plus half the maximum frequency offset. This improves the detection (stronger correlation peaks) for at least one of the 2 frequencies. For example, if the local oscillator has a frequency of 2 GHz+/− 11 kHz, then the estimation process is launched with subsequent frequencies 2 GHz+5.5 kHz and 2 GHz-5.5 kHz.

Thus the invention provides a new rule of selection of a peak of correlation. The validation of a peak of correlation is not made anymore in regard to a threshold as in the prior art, but in regard to the repetition of the peak on two time windows. Such a method improves the detection of peaks corresponding to a correlation point, between a reference code locally available at the receiver and a current input signal corresponding to this reference code, whose amplitude has been decreased by phenomenon such as, for example, in radio communications, fading, cell boundary or high frequency offset.

In one embodiment, when no peak has been selected, the method further comprises the following iterative steps of, until either a peak is selected or i equals nₘₐₓ, where i is an integer index initialized to 2 and where nₘₐₓ is a fixed integer value;

if the peak identified in the i^{th} correlation signal has not been selected, calculating a (i+1)^{th} correlation signal, along a (i+1)^{th} time window of the same duration as the i^{th} time window, indicative of the correlation between the code and at least one (i+1)^{th} slice of the input signal;

identifying a peak in the (i+1)^{th} correlation signal;

if the location of the peak identified in the (i+1)^{th} correlation signal substantially corresponds to the location of the peak identified in a respective signal among the first, the second, . . . , the i^{th} correlation signals, selecting the peak identified in the (i+1)^{th} correlation signal; else reiterate the steps by incrementing i by 1.

Such an arrangement decreases the probability of the non-detection of a peak of correlation.

In case that the correlation is calculated with several consecutive (i+1)^{th} slices of the input signal, the size of each (i+1)^{th} slice corresponds to said duration. The beginnings of the i^{st} and (i+1)^{th} slices are spaced one from the other by an integer multiple of said duration.

In one embodiment, the method further comprises the following step:

if, for an integer i equal or superior to 1, the location of the peak identified in a respective signal among the first, . . . , the i^{th} correlation signals is spaced, from the location of the peak identified in the (i+1)^{th} correlation signal, of less than +/− delta, where delta is a determined value, selecting the peak identified in the (i+1)^{th} correlation signal for synchronization.

This feature further improves the detection of a correlation point, by taking into account the timing drift due to frequency offset between receiver and transmitter, and compensating at least partially for this timing drift.

In an embodiment, delta is a function of at least a frequency offset value between a local oscillator of the base station and a local oscillator of the mobile station.

In another embodiment, the delta is a function of the sum of the total number of slices, from the 1^{st} slices up to the (i+1)^{th} slices considered in the current i^{th} iteration. This update allows to compensate still more precisely for the timing drift due the frequency offset.

According to a second aspect of the invention, there is provided a method of synchronization of a receiver in a radio communications system, comprising the steps of a method according to the first aspect of the invention, the peak selected being used for said synchronization.

According to a third aspect of the invention, there is provided a module for the selection of a maximum peak in a signal of correlation between a code and an input signal indicating periodically the said code, the said device comprising means in order to implement a method according the first aspect of the invention.

According to a fourth aspect of the invention, there is provided a mobile station adapted for receiving an input signal comprising periodically a code on a radio channel, from a transmitter, said mobile station comprising a module according the third aspect of the invention.

According to a fifth aspect of the invention, there is provided a computer program product comprising one or more stored sequences of instructions that are accessible to a processor and which, when executed by the processor, cause the processor to carry out the steps of a method according to the first aspect of the invention.

### BRIEF DESCRIPTION OF THE DRAWINGS

The present invention is illustrated by way of example, and not by way of limitation, in the figures of the accompanying drawings and in which:

FIG. 1 shows diagrammatically a device adapted to determine slot timing reference;

FIG. 2 shows detected peaks in several time windows, for two selection procedure steps;

FIG. 3 is a diagram indicating the drift versus the number of slots.

### DESCRIPTION OF PREFERRED EMBODIMENTS

In one embodiment of the invention, an UMTS network includes base stations BS and mobile stations MS. The radio communications between the base stations BS and mobile stations MS are WCDMA-compliant. The frequency of the local oscillator of the base station BS is equal to 2 GHz. In an embodiment, the frequency of the local oscillator of a mobile station MS is 2 GHz with an accuracy +/−11 KHz. In said embodiment, the frequency offset FOₘₐₓ equal to +/−11 kHz is the maximum possible offset for the mobile station MS. It should be noted however that the present invention is applicable to embodiments having a larger or a smaller accuracy. In practice the accuracy will improve in the future.

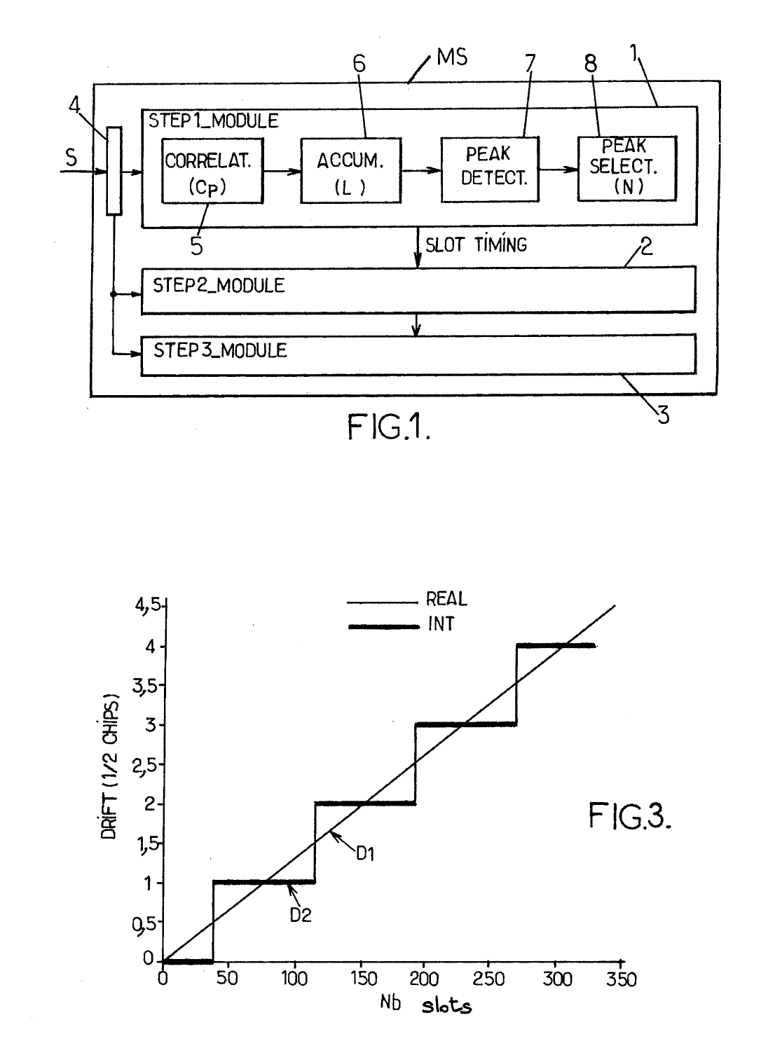

Referring to FIG. 1, when switched on, the mobile station MS is adapted to process the initial cell search 3-steps procedure for acquiring a cell signal and synchronizing therewith, in order to exchange information with the base station BS. The mobile station MS comprises a receiver stage 4, and three modules, respectively STEP1_module referenced 1, STEP2_module referenced 2, STEP3_module referenced 3, each designed in order to process respectively the first step, the second step and the third step of the initial cell search 3-steps procedure.

The receiver stage 4 is adapted to receive an input signal S transmitted by a base station, and to oversample it by 2.

The STEP1_module 1 comprises a correlator 5 associated to a locally generated synchronization code Cₚ, an accumulator 6, a peak detector 7 and a peak selector 8.

In an embodiment, an HFO estimation is processed based on the information get from the 3-steps procedure. A method according to the invention is launched more than once in order to optimize such a HFO estimation process. For example a first and a second process using the method of the invention are carried out at mutually different frequencies of the mobile station local oscillator. The first frequency is for example the nominal frequency minus half the maximum frequency offset and the second frequency is the nominal frequency plus half the maximum frequency offset. This improves the detection (stronger correlation peaks) for at least one of the 2 frequencies. The local oscillator of the mobile station having a frequency of 2 GHz+/−11 kHz, then the estimation process, and consequently the method according to the invention, is launched with subsequent frequencies 2 GHz+5.5 kHz and 2 GHz-5.5 kHz, and considering (working hypothesis) a common maximum frequency offset FO′ equal to +/−5.5 kHz=+/−11 kHz/2).

One process of the first step of the 3-steps procedure will now be described herebelow in regard to one embodiment of the invention, for example for a frequency of the local oscillator of the mobile station equal to 2 GHz+5.5 kHz, and considering a frequency offset maximum FO′ equal to +/− 5.5 kHz. Nevertheless, the invention can be implemented in any one of the 3 steps of this procedure and for any frequency or maximum frequency offset of the local oscillator.

As explained previously, each base station BS inserts the primary synchronization code Cₚ code at the beginning of each slot transmitted on the PSCH channel.

In the first step of this procedure, the STEP1_module 1 of the mobile station MS searches for the slot timing reference of a currently received signal S through the PSCH channel by correlating the signal S with the Cₚ code composed of 256 chips, generated by the mobile station MS.

Each frame of signal S transmitted on the PSCH channel from a base station lasts 10 ms and includes 15 slots. Each slot is composed of 10 symbols. Each symbol is itself composed of 256 chips.

Each consecutive slice of the signal S, of duration a slot duration Ds=2560 chips=10.15⁻¹ ms, is oversampled by the receiver stage 4.

Each slice SL_i, of duration equal to the slot duration Ds, corresponds thus to 5120 signal samples Ech_i(1), Ech_i(2), . . . , Ech_i(5120), that are half-chips spaced: SL_i={Ech_i(1), Ech_i(2), . . . , Ech_i(5120)}, i integer >0.

Each sample Ech_i(j), i integer >0 and j integer ∈ [1,5120] currently received by the receiver stage is provided to the correlator 5, that computes then the correlation value Cor_i(j) with the 256 chips Cₚ₁ to Cp₂₅₆ of the primary synchronization code Cₚ and with the sample Ech_i(j) and the 511 previous samples provides to the correlator 5 by the receiver stage 4.

For example Cor_i(j)=Ech_i(j).Cₚ₂₅₆+Ech_i(j-1). Cₚ₂₅₆+Ech_i(j-2). Cₚ₂₅₅+Ech_i(j-3). Cₚ₂₅₅ . . . +Ech_i(j-510). Cₚ₁+Ech_i(j-511). Cₚ₁ , when j is superior to 511 (else the last samples of the slice SL_i-1 are used).

Two consecutive correlation values Cor_i(j), Cor_i(j+1) computed by the correlator are half-chip spaced.

These correlations values computed by the correlator 5 are provided to the accumulator 6. From the correlation values received corresponding to L successive slices of signal S, the accumulator 6 provides a mean correlation profile.

For example, a first mean correlation profile CorProf_1 is defined by the 5120 consecutive values CorProf_1(1), CorProf_1(2), . . . CorProf_1(5120) respectively affected to the half-chips 1 to 5120.

And CorProf_1(j)=Cor_1(j)+Cor_2(j) . . . +Cor_L(j) for j=1 to 5120. To each respective half-chip j from 1 to 5120 is affected the mean correlation value computed in regards to L consecutive correlation values that were computed by the correlator 5 and that correspond to this respective half-chip.

And more generally, an n^{th} mean correlation profile CorProf_n is defined by the respective 5120 consecutive values CorProf n(1), CorProf n(2), . . . CorProf n(5120) for the 5120 consecutives half-chips 1 to 5120, with:

CorProf_{—}n(j)=Cor_((n-1).L+1)(j)+Cor_((n-1).L+2)(j) . . . +Cor_{—}n.L(j) for j=1 to 5120.

The size of the time window corresponding to each mean correlation profile Cor-Prof_n is equal to the duration of a slot (5120 half-chips).

These mean correlation profile values computed by the accumulator 6 are successively provided to the peak detector 7. Then the peak detector 7 identifies, for each mean correlation profile CorProf_n, the half-chip jₘₐₓ, between 1 to 5120, corresponding to the maximum value CorProf_n(jₘₐₓ), which means ∀j=1 to 5120, CorProf_n(jₘₐₓ) is superior or equal to CorProf_n(j).

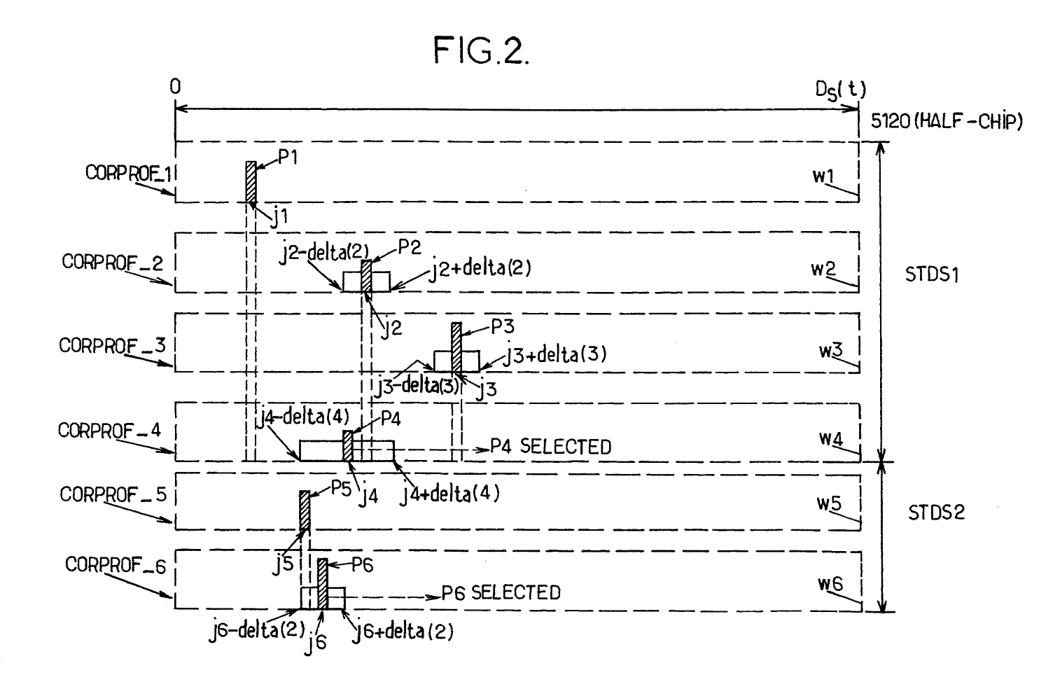

Referring to FIG. 2 that represents 6 time windows W1 to W6, which length thereof is 5120 half-chips (one slot duration Ds), the peak detector 7 identifies a peak P1 located at the half-chip j1, in the time window W1 corresponding to the mean correlation profile CorProf_1, which is the result of the correlation values accumulation on the slices 1 to L of the signal S.

The peak detector 7 identifies a peak P2 located at the half-chip j2, in the time window W2 corresponding to the mean correlation profile CorProf_2, that is the result of the correlation accumulation values on the slices L+1 to 2L of the signal S.

The peak detector 7 identifies a peak P3 located at the half-chip j3, in the time window W3 corresponding to the mean correlation profile CorProf_3, that is the result of the correlation values accumulation on the slices 2L+1 to 3L of the signal S.

The peak detector 7 identifies a peak P4 located at the half-chip j4, in the time window W4 corresponding to the mean correlation profile CorProf_4, that is the result of the correlation values accumulation on the slices 3L+1 to 4L of the signal S.

The peak detector 7 identifies a peak P5 located at the half-chip j5, in the time window W5 corresponding to the mean correlation profile CorProf_5, that is the results of the correlation values accumulation on the slices 4L+1 to 5L of the signal S.

The peak detector 7 identifies a peak P6 located at the half-chip j6, in the time window W6 corresponding to the mean correlation profile CorProf_6, that is the results of the correlation values accumulation on the slices 5L+1 to 6L of the signal S.

The peak detector 7 provides the peak selector 8 with the position of the detected maximum peak for each mean correlation profile once it is processed.

The peak selector 8 processes then a peak selection, in order to select a peak that will be considered as the slot timing reference, and that will be used to process the following steps 2 and 3 of the 3-steps procedure.

The peak selector 8 is adapted, in one selection operation, to implement the following iterative steps:

receiving the location, in a first time window of 5120 half-chips length, of a first maximum correlation peak;

receiving the location, in a second time window of 5120 half-chips length, of a second maximum correlation peak;

if the location of the first maximum correlation peak corresponds to the location of the second maximum correlation peak +/−delta2, selecting the said second peak for synchronization;

else, by initializing k to 2 and reiterating the following steps, the iteration having to be stopped as soon as either a peak is selected or k=N:

receiving the location, in a k+1^{th} time window of 5120 half-chips length, of a k+1^{th} maximum correlation peak;

if the location of one of the first, . . . and the k^{th} maximum correlation peaks corresponds the location of the k+1^{th} maximum correlation peak +/−delta(k+1), selecting the said k+1^{th} peak for synchronization;

else k=k+1.

when a peak has been selected, providing it to the STEP2_module, in order to further process the second step of the procedure based upon a slot timing reference located at the last selected peak.

The process of selection thus covers a maximum of N.L slices of signals.

In the described embodiment described in reference to FIG. 2, a maximum number N equal to 6 has been chosen. It represents the maximum number of time windows successively taken into account in a selection operation. L is the number of slices of signal accumulated by the accumulator 6. L is for example taken equal to 35 and delta(2)=2 half-chips, delta(3)=2 half-chips; delta(4)=3 half-chips; delta (5)=3 half-chips; delta(6)=4 half-chips.

Two successive examples of selection operation, STDS1 and STDS2, will now be described referring to FIG. 2.

In the first selection operation STDS1, the peak selector 8 first receives the coordinate j1 of the peak P1 detected for the mean correlation profile CorProf_1, corresponding to the time window W1. Then the peak selector 8 receives the coordinate j2 of the peak P2 detected for the mean correlation profile CorProf_2, corresponding to the time window W2. The correlator 8 compares the location (j1) of the peak P1 in the time window W1 with the location (j2) of the peak P2 in the time window W2+/− delta(2). But j1 ∈ [j2−delta(2); j2+delta(2)].

The peak P2 is thus not selected. And k:=2 (so k<6, a new iteration can be done).

Then the peak selector 8 receives the coordinate j3 of the peak P3 detected for the mean correlation profile CorProf_3, corresponding to the time window W3. The correlator 8 compares the locations (j1 and j2) of the peaks P1, P2 in the time window W1, W2 with the location (j3) of the peak P3 in the time window W3+/− delta(3). But neither j1, nor j2 ∈ [j3 −delta(3); j3+delta(3)].

The peak P3 is thus not selected. And k:=3 (so k<6, a new iteration can be done in the same selection operation).

Then the peak selector 8 receives the coordinate j4 of the peak P4 detected for the mean correlation profile CorProf_4, corresponding to the time window W4. The correlator 8 compares the locations (j1, j2 and j3) of the peaks P1, P2 and P3 in the time window W1, W2, W3 with the location (j4) of the peak P4 in the time window W4+/−delta(4). If j1 and j3 ∈/ [j4−delta(4); j4+delta(4)], j2 ∈ [j4−delta(4); j4+delta(4)]. Consequently the correlator 8 selects the peak P4.

The location of the peak P4 in the time window W4 is then provided by the STEP1_module 1 to the STEP2_module 2, which will process the step 2 of the 3-steps procedure, taking into account that the current slot timing reference is j4 (i.e. the position of the synchronization code Cₚ in the slot corresponds to j4).

The correlator 8 goes on a further selection operation STDS2, referring to FIG. 2.

In the second selection operation STDS2, the peak selector 8 first receives the coordinate j5 of the peak P5 detected for the mean correlation profile CorProf_5, corresponding to the time window W5. Then the peak selector 8 receives the coordinate j6 of the peak P6 detected for the mean correlation profile CorPro_6, corresponding to the time window W6. The correlator 8 compares the location (j5) of the peak P5 in the time window W5 with the location (j6) of the peak P6 in the time window W6+/−delta(2). As j5 ∈ [j6−delta(2); j6+delta(2)], the correlator 8 selects the peak P6.

The location of the peak P6 in the time window W6 is then provided by the STEP1_module 1 to the STEP2_module 2, which will process the step 2 of the 3-steps procedure, taking into account that a new current slot timing reference is j6.

The delta values (delta(2)=2 half-chips, delta(3)=2 half-chips; delta(4)=3 half-chips; delta (5)=3 half-chips; delta(6)=4 half-chips) corresponding to the two selection operations STDS1 and STDS2 illustrated in FIG. 2 have been chosen in reference to FIG. 3, that shows the timing drift in the mobile station MS according to the total number of slices of signal from the starting point of the measure of the drift, with a frequency offset equal to the maximum frequency offset FO′ of 5.5 KHz. The real drift corresponds to the straight line D1. The staircase function D2 represents the real drift rounded to the nearest integer.

Delta(i) has been taken equal to the sum of a margin of 1 half-chip and of the drift (given by the function D2) that occurs when the number of slices is equal the total number of slices of signal S used for computing the mean correlation profiles from the first mean correlation profile associated to the first time window until the i^{th} mean correlation profile associated to the i^{th} time window, for i=2 to 6.

The half-chip of margin added to the drift correspond in this embodiment to the additional drift due to the processing chain to the peak selector 8, mainly due to the correlator 5.

More generally, the value for delta(i) can be the following:

$$\frac{fo \times {N}_{itotal} \times Ds}{F \times {d}_{c}} + Margin ,$$

where fo is the maximum frequency offset considered (in the particular embodiment described fo=FO′=5.5 KHz); Nᵢₜₒₜₐₗ is the total number of slices of signal S used for computing the mean correlation profiles from the first mean correlation profile associated to the first time window until the i^{th} mean correlation profile associated to the i^{th} time window, for i=2 to 6; Ds is the duration of a slice; d_{c} is the duration of a chip and F is the reference frequency of the oscillator of the base station BS and Margin is the drift due to the processing chain prior to the peak selector.

The use of the range +/−delta (i) in the selection process of a correlation peak is to take into account the drift of the mobile station MS, and to compensate for it.

In one embodiment, the value of the frequency offset FO to calculate delta(i) is chosen equal to the maximum possible frequency offset in the mobile station MS, which depends on the accuracy of the local oscillator of the mobile station MS.

In another embodiment, the value of the frequency offset FO to calculate delta(i) is chosen equal to last estimation of the frequency offset in the mobile station MS and is regularly updated.

In another embodiment, the delta(i) values, i=1 à 6, can be equal to zero.

In another embodiment, the delta(i) values, i=1 à 6, can be equal to a same value, for example 1 chip, or n chips (with for example n<5) in order to take into account a timing drift due to the frequency offset in the mobile station.

The invention proposes thus a method and a module enabling the selection of a peak of correlation between a code and an input signal received by a receiver on a radio channel wherein said code is periodically transmitted by a transmitter. These method and module enable to improve the performance of the selection in case of phenomenon such as fading or frequency offset between the receiver and the transmitter, or when the receiver is located at cell boundary. The use of the invention for example in synchronization methods, such as cell search method in UMTS systems or in GSM systems, allows to perform a reliable selection of the timing references.

The invention has been described here above with reference to the Figures in a WCDMA radio communication system. Nevertheless the invention can be implemented in every radio system where it is necessary to correlate an input signal and a code in order, for example, to decide the location of the point of synchronization.

The present invention can be implemented in hardware, software, or a combination of hardware and software. Any processor, controller, or other apparatus adapted for carrying out the functionality described herein is suitable. A typical combination of hardware and software could include a general purpose microprocessor (or controller) with a computer program that, when loaded and executed, carries out the functionality described herein.

The present invention can also be embedded in a computer program product, which comprises all the features enabling the implementation of the methods described herein, and which—when loaded in an information processing system—is able to carry out these methods. Computer program means or computer program in the present context mean any expression, in any language, code or notation, of a set of instructions intended to cause a system having an information processing capability to perform a particular function either directly or after either or both of the following a) conversion to another language. The computer or machine readable medium may include non-volatile memory, such as ROM, Flash memory, Disk drive memory, CD-ROM, and other permanent storage. Additionally, a computer or machine readable medium may include, for example, volatile storage such as RAM, buffers, cache memory, and network circuits. Furthermore, the computer or machine readable medium may comprise computer or machine readable information in a transitory state medium such as a network link and/or a network interface, including a wired network or a wireless network, that allow a device to read such computer or machine readable information.

A person skilled in the art will readily appreciate that various parameters disclosed in the description may be modified and that various embodiments disclosed and/or claimed may be combined without departing from the scope of the invention.

1. A method for the selection of a maximum peak in a correlation signal corresponding to the correlation between a code and an input signal indicating periodically said code, the method comprising:
calculating a first correlation signal, along a first time window of a given duration, indicative of the correlation between the code and at least one first slice of the input signal;
identifying a peak of the first correlation signal;
calculating a second correlation signal, along a second time window of the same duration as the first time window, indicative of the correlation between the code and at least one second slice;
identifying a peak in the second correlation signal;
if the location of the peak identified in the first correlation signal substantially corresponds to the location of the peak identified in the second correlation signal, selecting the peak identified in the second correlation signal.

2. The method according to claim 1, further comprising, when no peak has been selected, until either a peak is selected or i equals nₘₐₓ, where i is an integer index initialized to 2 and where nₘₐₓ is a fixed integer value;
if the peak identified in the i^{th} correlation signal has not been selected, calculating a (i+1)^{th} correlation signal, along a (i+1)^{th} time window of the same duration as the i^{th} time window, indicative of the correlation between the code and at least one (i+1)^{th} slice of the input signal;
identifying a peak in the (i+1)^{th} correlation signal;
if the location of the identified peak in the (i+1)^{th} correlation signal in the (i+1)^{th} time window substantially corresponds to the location of the peak identified in one respective signal among the first, the second, . . . and the (i)^{th} correlation signals, selecting the peak identified in the (i+1)^{th} correlation signal; else reiterating by incrementing i by one.

3. The method according to claim 1, comprising: if, for an integer i equal or superior to 1, the location of the peak identified in a respective signal among the 1^{st}, . . . , the i^{th} correlation signals in its respective time window, is spaced, from the location of the peak identified in the (i+1)^{th} correlation signal, of less than delta, where delta is a determined value, selecting the peak identified in the (i+1)^{th} correlation signal.

4. The method according to claim 3, wherein delta is a function of a frequency offset between a local oscillator of the transmitter and a local oscillator of the receiver, and/or wherein delta is a function of the sum of the total number of slices, from the first slices up to the (i+1)^{th} slices considered in the current iteration.

5. A method of synchronization of a receiver receiving on a radio channel an input signal from a transmitter to be synchronized with, wherein the input signal indicates periodically a code, comprising:
calculating a first correlation signal, along a first time window of a given duration, indicative of the correlation between the code and at least one first slice of the input signal;
identifying a peak of the first correlation signal;
calculating a second correlation signal, along a second time window of the same duration as the first time window, indicative of the correlation between the code and at least one second slice;
identifying a peak in the second correlation signal;
if the location of the peak identified in the first correlation signal substantially corresponds to the location of the peak identified in the second correlation signal, selecting the peak identified in the second correlation signal; and
the selected peak being used for said synchronization.

6. A module for the selection of a maximum peak in a correlation signal corresponding to the correlation between a code and an input signal indicating periodically said code, the module comprising:
correlation calculation means for:
calculating a first correlation signal, along a first time window of a given duration, indicative of the correlation between the code and at least one first slice; and
calculating a second correlation signal, along a second time window of the same duration as the first time window, indicative of the correlation between the code and at least one second slice;
peak identification means for identifying a peak in the first correlation signal and identifying a peak in the second correlation signal;
peak selection means for, if the location of the peak identified in the first correlation signal corresponds substantially to the location of the peak identified in the second correlation signal, selecting the peak identified in the second correlation signal.

7. The module according to claim 6, wherein the correlation calculation means, the peak identification means and the peak selection means are designed for performing, in a new iteration, if no peak has been selected by the peak selection means, the iteration being repeated until either a peak is selected by the peak selection means or i equals nₘₐₓ, where i is an integer index initialized to two and where nₘₐₓ is a fixed integer value:
if the peak selection means have not selected the peak identified in the i^{th} correlation signal, the correlation calculation means are adapted for calculating a (i+1)^{th} correlation signal, along a (i+1)^{th} time window of the same duration as the i^{th} time window, indicative of the correlation between the code and at least one (i+1)^{th} slice of the input signal;
peak identification means are adapted for identifying a peak in the (i+1)^{th} correlation signal; and
the peak selection means are adapted for, if the location of the peak identified in the (i+1)^{th} correlation signal corresponds substantially to the location of the peak identified in a respective signal among the first, the second, . . . , the i^{th} correlation signals, selecting the peak identified in the (i+1)^{th} correlation signal; else the peak detection selecting means are adapted for reiteration by incrementing i by one.

8. The module according to claim 6, wherein the peak selection means are adapted for, if, for an integer i equal or superior to 1, the location of the peak identified in a respective signal among the first, . . . , the i^{th} correlation signals, is spaced, from the location of the peak identified in the (i+1)^{th} correlation signal, of less than +/−delta, delta being a fixed value, selecting the peak identified in the (i+1)^{th} correlation signal.

9. The module according to claim 8, wherein delta is a function of a frequency offset between a local oscillator of the transmitter and a local oscillator of the receiver and or a function of the sum of the total number of slices, from the 1^{st} slices up to the (i+1)^{th} slices considered in the current iteration.

10. A mobile station for receiving an input signal comprising periodically a code, on a radio channel from a transmitter, said mobile station comprising a module for the selection of a maximum peak in a correlation signal corresponding to the correlation between a code and an input signal indicating periodically said code, the module comprising:
correlation calculation means for:
calculating a first correlation signal, along a first time window of a given duration, indicative of the correlation between the code and at least one first slice; and
calculating a second correlation signal, along a second time window of the same duration as the first time window, indicative of the correlation between the code and at least one second slice;
peak identification means for identifying a peak in the first correlation signal and identifying a peak in the second correlation signal;
peak selection means for, if the location of the peak identified in the first correlation signal corresponds substantially to the location of the peak identified in the second correlation signal, selecting the peak identified in the second correlation signal.

11. A computer program product comprising one or more stored sequences of instructions that are accessible to a processor and which, when executed by the processor, cause the processor to carry out a method for the selection of a maximum peak in a correlation signal corresponding to the correlation between a code and an input signal indicating periodically said code, the method comprising:
calculating a first correlation signal, along a first time window of a given duration, indicative of the correlation between the code and at least one first slice of the input signal;
identifying a peak of the first correlation signal;
calculating a second correlation signal, along a second time window of the same duration as the first time window, indicative of the correlation between the code and at least one second slice;
identifying a peak in the second correlation signal;
if the location of the peak identified in the first correlation signal substantially corresponds to the location of the peak identified in the second correlation signal, selecting the peak identified in the second correlation signal.

12. The computer program product according to claim 11, further comprising, when no peak has been selected, until either a peak is selected or i equals nₘₐₓ, where i is an integer index initialized to 2 and where nₘₐₓ is a fixed integer value;
if the peak identified in the i^{th} correlation signal has not been selected, calculating a (i+1)^{th} correlation signal, along a (i+1)^{th} time window of the same duration as the i^{th} time window, indicative of the correlation between the code and at least one (i+1)^{th} slice of the input signal;
identifying a peak in the (i+1)^{th} correlation signal;
if the location of the identified peak in the (i+1)^{th} correlation signal in the (i+1)^{th} time window substantially corresponds to the location of the peak identified in one respective signal among the first, the second, . . . and the (i)^{th} correlation signals, selecting the peak identified in the (i+1)^{th} correlation signal; else reiterating by incrementing i by one.

13. The computer program product according to claim 11, comprising: if, for an integer i equal or superior to 1, the location of the peak identified in a respective signal among the 1^{st}, . . . , the i^{th} correlation signals in its respective time window, is spaced, from the location of the peak identified in the (i+1)^{th} correlation signal, of less than delta, where delta is a determined value, selecting the peak identified in the (i+1)^{th} correlation signal.

14. The computer program product according to claim 13, wherein delta is a function of a frequency offset between a local oscillator of the transmitter and a local oscillator of the receiver, and/or wherein delta is a function of the sum of the total number of slices, from the first slices up to the (i+1)^{th} slices considered in the current iteration.

15. The mobile station according to claim 10, wherein the correlation calculation means, the peak identification means and the peak selection means are designed for performing, in a new iteration, if no peak has been selected by the peak selection means, the iteration being repeated until either a peak is selected by the peak selection means or i equals nₘₐₓ, where i is an integer index initialized to two and where nₘₐₓ is a fixed integer value:
if the peak selection means have not selected the peak identified in the i^{th} correlation signal, the correlation calculation means are adapted for calculating a (i+1)^{th} correlation signal, along a (i+1)^{th} time window of the same duration as the i^{th} time window, indicative of the correlation between the code and at least one (i+1)^{th} slice of the input signal;
peak identification means are adapted for identifying a peak in the (i+1)^{th} correlation signal; and
the peak selection means are adapted for, if the location of the peak identified in the (i+1)^{th} correlation signal corresponds substantially to the location of the peak identified in a respective signal among the first, the second, . . . , the i^{th} correlation signals, selecting the peak identified in the (i+1)^{th} correlation signal; else the peak detection selecting means are adapted for reiteration by incrementing i by one.

16. The mobile station according to claim 10, wherein the peak selection means are adapted for, if, for an integer i equal or superior to 1, the location of the peak identified in a respective signal among the first, . . . , the i^{th} correlation signals, is spaced, from the location of the peak identified in the (i+1)^{th} correlation signal, of less than +/−delta, delta being a fixed value, selecting the peak identified in the (i+1)^{th} correlation signal.

17. The mobile station according to claim 16, wherein delta is a function of a frequency offset between a local oscillator of the transmitter and a local oscillator of the receiver and or a function of the sum of the total number of slices, from the 1^{st} slices up to the (i+1)^{th} slices considered in the current iteration.

18. A method for the selection of a maximum peak in a correlation signal corresponding to the correlation between a code and an input signal received by a receiver on a radio channel wherein a transmitter transmits periodically the said code, comprising providing a selection criteria that is the time recurrence of the same position of peaks of correlation, taking into account a margin around the peak position compensating for a drift due to a frequency offset between the receiver and the transmitter.
